(19) United States
(12) Patent Application Publication
(10) Pub. No.: US 2010/0235897 A1
(43) Pub. Date: Sep. 16, 2010

(54) PASSWORD MANAGEMENT

(76) Inventors: Jeremy R. Mason, Ipswich (GB); Neil A. Emms, Ipswich (GB); Colin R. Paterson, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/679,432

(22) PCT Filed: Aug. 15, 2008
(86) PCT No.: PCT/GB2008/002788

§ 371 Date: Mar. 22, 2010

(30) Foreign Application Priority Data
Sep. 26, 2007 (GB) 0718817.0

(51) Int. Cl. H04L 9/32; G06F 21/00

(52) U.S. Cl. 726/7

(57) ABSTRACT

A method for recording a password for providing access to secure resources in a computer network, including a user establishing a session via the computer network in which the user is in communication with a password authority via the session; the user identifying themselves to the password authority via the session and requesting a password via the session; the password authority sending a code to the user otherwise than via the session; the user receiving the code and providing the code to the password authority via the session; the user providing a proposed password value to the password authority via the session; the password authority receiving and checking the validity of the code provided by the user and, if the code entered is valid, recording the proposed password value entered by user; in which the code is only valid if provided via the session via which the password is requested.

The present invention relates to recording a password for providing access to secure resources.

Secure resources such as sensitive or valuable information, cash from an ATM dispenser or a restricted geographical location are increasingly accessed using computers and computer networks. Both on a personal level, such as with online banking, and at work, where confidential information is increasingly made accessible via intranets and the Internet, the use of passwords to restrict access to authenticated users is becoming ever more important. Typically, the security details (login name and password) required may differ for each secure resource. One problem with the proliferation of password-protected resources is the difficulty users can experience remembering their security details for different sites.

Allocation and use of a password is administered by a password authority. If a user is the victim of an unauthorised person who, seeking illicitly to impersonate them, submits the wrong password too many times, the current password will be disabled by the password authority, requiring the user to obtain a new password in order to obtain access to the secure resource. Similarly, if the user forgets their password, they may need to request a new password from the password authority.

Typically, users who need to reset their password launch a self-service application from their web browser. The self-service application communicates with the password authority to request the password reset. In order to obtain the new password, the user will first have to prove their identity other than by using their forgotten or disabled password. This can be done by the user answering one or more questions. Other, more technical means of proving identity, such as a hardware security key or a biometric sample, may also be used but will result in increased cost and complexity.

Once the user's identify has been established, they can obtain a new, valid password via the self-service application.

One way to make the security details more memorable is to make the user's login name the same as their email address. An email address is, necessarily, unique to the user and is therefore useful in identifying a specific individual and frequent use of an email address makes it less likely to be forgotten by the user. Use of the user's email address as a login name poses a problem, however, when it comes to allowing a user to change or reset their password (often referred to as “self-service password reset”). Selfservice password reset can be particularly useful when a user has forgotten their current password or the current password has been disabled due to too many failed login attempts, however, there will be a security risk where the newly-generated password is provided to the user by email. If the email containing the new password were to be intercepted, then security would have been breached by exposing both the username and password simultaneously.

There is therefore a need for a secure system to allow a password to be reset or a new password to be registered for users where the username is the same as the user's email address.

The inventor has provided a system in which, instead of a new password being provided by the system, the user is able to propose their own choice of new password to the system. The invention provides a method for recording a password for providing access to secure resources in a computer network, the method including the steps of: a user establishing a session via the computer network in which the user is in communication with a password authority via the session; the user identifying themselves to the password authority via the session and requesting recording of a password via the session; the password authority sending a code to the user otherwise than via the session; the user receiving the code and providing the code to the password authority via the session; the user providing a proposed password value to the password authority via the session; the password authority receiving and checking the validity of the code provided by the user and, if the code entered is valid, recording the proposed password value entered by user; in which the code is only valid if provided via the session via which the recording of a password is requested.

According to an aspect of the invention, the code is only valid if entered within a set time limit after the code is sent by the password authority to the user.

According to a further aspect of the invention, the code is sent to the user by means of a communications system; in which the user is identified in the communications system by an address associated with the user by the password authority.

According to a further aspect of the invention, the address is an email address.

The invention may also include the steps of, on receiving the request from the user, recording a temporary password and upon receiving the password value provided by the user using the temporary password to authorise recording of the password value provided by user.

According to a further aspect of the invention, the or each password is recorded in an authentication database.

The invention also provides a password authorisation system comprising a server for establishing a session via a computer network with a user, in which the user is in communication with the password authority via the session; in which the server is arranged to receive a request for recording of a password from the user via the session; in which the password authorisation system is arranged, in response to the request, to send a code to the user otherwise than via the session; in which the server is arranged to receive the code and a proposed password value from the user via the session; in which the password authorisation system is arranged to receive and check the validity of the code received from the user and, if the code entered is valid, to record the proposed password value received from the user; in which the code is only valid if provided via the session via which the recording of a password is requested.

According to an aspect of the invention, the code is only valid if entered within a set time limit after the code is sent by the password authority to the user.

According to a further aspect of the invention, the system comprises a communications server for sending the code to the user via a communications system; in which the user is identified in the communications system by an address associated with the user by the password authority.

According to a further aspect of the invention, the address is an email address.

According to a further aspect of the invention, the system is arranged, on receiving the request from the user, to record a temporary password and, upon receiving the password value provided by the user, to use the temporary password to authorise recording of the password value provided by user.

According to a further aspect of the invention, the or each password is recorded in an authentication database.

According to a further aspect of the invention, a carrier medium may be provided carrying a computer program or set of computer programs adapted to carry out, when said program or programs is run on a data-processing system, each of the steps of the invention.

The invention also provides a method for recording a password for providing access to secure resources in a computer network, the method including the steps of: a user establishing a session via the computer network in which the user is in communication with a password authority via the session; the user identifying themselves to the password authority via the session and requesting recording of a password via the session; the password authority sending a code to the user via a communications system separate from the session; the user receiving the code and providing the code to the password authority via the session; the user providing a proposed password value to the password authority via the session; the password authority receiving and checking the validity of the code provided by the user and, if the code entered is valid, recording the proposed password value entered by user; in which the code is only valid if provided via the session via which the recording of a password is requested.

According to a further aspect of the invention, the communications system forms part of the computer network.

To aid understanding of the invention, embodiments will now be described by way of example, with reference to the drawings in which:

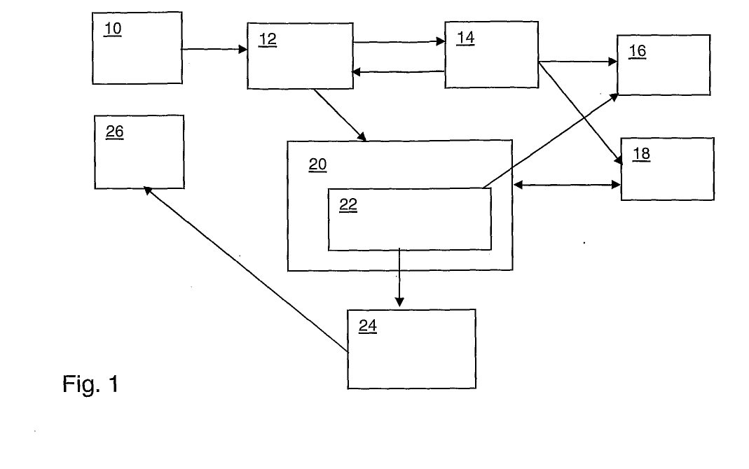

FIG. 1 shows a block diagram of a system for recording of a password according to the invention;

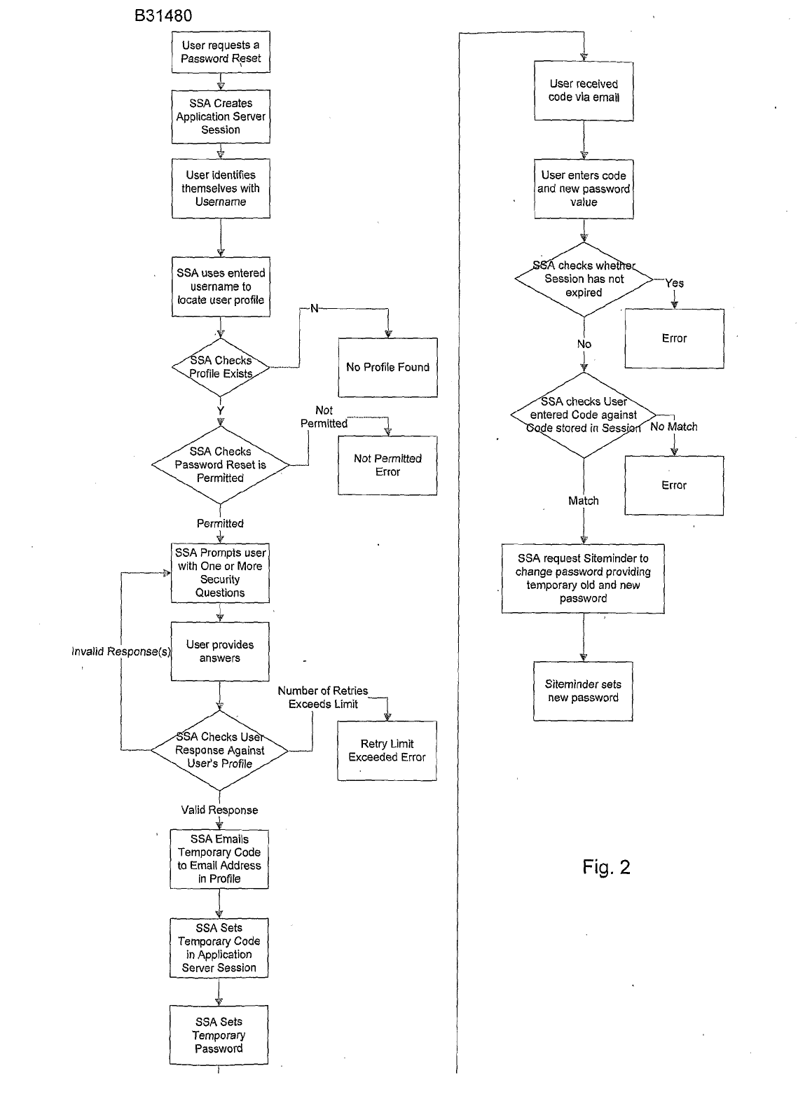

FIG. 2 shows a flow chart of a password reset operation according to the invention.

A system for exploiting password protection to provide secure access to a resource according to the invention will be described with reference to FIG. 1. FIG. 1 shows a password-based secure access system based on the SiteMinder system, although other password-based access management systems could equally be used. Netegrity® SiteMinder is a commercially available access management system featuring policy-based authentication and authorization management and supporting single sign-on (SSO).

The system according to FIG. 1 comprises browser 10 through which a user of the system (not shown) accesses functionality provided by application server 20 (for example a BEA Weblogic® server). The user connects via web server 12, which hosts one or more web agents (not shown). Web server 12 is in communication with policy server 14, and application server 20. Policy server 14 is in communication with authentication lightweight directory access protocol (LDAP) server 16 and authorization lightweight directory access protocol (LDAP) server 18. Authentication LDAP server 16 comprises a database of information on authenticated users. Authorization LDAP server 18 comprises a database of information on authorized users. Alternatively, the information on authenticated or authorized users could be provided by RDBMS servers in an alternative arrangement. Application server 20 comprises self-service application 22 and is, itself, connected to authorization LDAP server 18. Self-service application 22 is connected to authentication LDAP server 16. Application server 20 is also connected to email server 24, for example a Simple Mail Transfer Protocol (SMTP) server, which is arranged to provide email messages to the user via an email communication system that is separate from the connections making up the web browser session. Hence, access to the email system does not provide access to the session. The emails are delivered to mail client 26 and to other users (not shown) via respective further email clients (not shown). Email server 24 directs messages to the appropriate users according to email addresses contained in the message header, as in well known. Typically, email client 26 and the user's web browser 10 will be run on the same user computer, although this is not essential.

The user's rights and privileges with regard to access to resources is policed by a password authority comprising web server 12, policy server 14, authentication LDAP server 16, authorization LDAP server 18 and application server 20.

Before proceeding with the description of the invention, we describe a conventional web browser session. Conventional web browsers use the HTTP protocol to communicate with web servers. The HTTP/1.0 protocol is a connectionless protocol, meaning that, once a browser's request for a web page is satisfied by the web server, the connection between the web server and the user's browser is closed.

HTTP connections are generally very short-lived but a user may need to interact with a web site over a set of successive connections. For example, if the user wishes to access several pages from the same web site, a new connection will need to be set up to request each further page. HTTP/1.0 is also stateless, in that the web server does not store information relating to a connection once that connection has been terminated. Because a new connection has to be established each time a request is sent to a web server, the web server does not know if the request is from the same user who made the previous request. In order to maintain continuity and avoid the need to input the same data repeatedly for each connection, a web browser session may be established between the user's browser and the web server that extends in time over the set of connections. The web server is able to track user data over a set of connections, e.g. as the user goes from page to page in a website, by means of session tracking. Session tracking refers to the mechanism that allows a session to be maintained over the course of several connections by including a cookie in each exchange between the user's browser and the web server. The cookie is generated by the server when it receives the first request from a user's browser. The cookie is sent to the requesting browser with information relating to the session that is then stored by the browser for use in subsequent communications with the server. The cookie identifies the state associated with the user and the session by means of a unique session ID and further contextual information. Subsequent requests from the browser to the same site are accompanied by the cookie to allow the web server to determine the state.

A web browser session will not be maintained indefinitely, for example: a session is normally set to expire following detection of a period of inactivity on the part of the user. Alternatively, a web server can be configured to terminate a user's session after a set time period. Termination will normally be accompanied by deletion of the related cookie. This avoids unnecessarily tying up resources at the web server. Upon termination, the web server will send the user's browser a message notifying the user that the current session has expired. Following expiry of the current session, the user will need to log back in if they wish to continue to access the same web site or resource.

A request for access to a secure resource may be initiated by the user (not shown) submitting a request comprising a username identifying the user and a password via browser 10 to web server 12. The username submitted with the request is forwarded to policy server 14. Policy server 14 authenticates the submitted username by checking against authenticated usernames held in a database, such as an authentication LDAP server 16. Once the user has been authenticated, policy server 14 provides the user with an encrypted cookie that contains information identifying the user. On receipt, the cookie is stored by the user's browser 10. The browser sends a copy of the cookie with subsequent communications from the user. Each cookie received from the user's browser 10 by web server 12 is forwarded to policy server 14 where it is decrypted so as to allow the user to be securely identified.

If the password entered by the user in the arrangement, described above, is invalid for any reason, the user will be invited to request a new password to be recorded. Alternatively, the user may be given the option at any time to request a change of password, for example, if they have forgotten the password or if they believe it might no longer be secure.

According to the present invention, instead of the newly-generated password being generated by the password authority and sent to the user via email, self-service application 22 generates a code according to rules that ensure that is distinct from a valid password. The code is sent to the user via email. Self-service application 22 instructs email server 24 to send the email to the user's email client 26. The user can access the email in the normal way and obtain the code. The user now selects a new value for recording as a password. The user then inputs the code to the self-service application along with a proposed value of their choosing for a new password (normally entered in duplicate to flag any typing errors). As indicated above, sessions are temporary in nature. For security, the code is only valid if entered during the current session between the user and the password authority, i.e. the session in which the password reset was requested by the user. If the code is obtained by an unauthorised party intercepting the email, it will not be of any value unless the third party also manages to gain access to the current session before it expires. In the normal run of events, this is expected to be extremely unlikely. As explained above, access to the email system does not provide access to the session.

According to a preferred embodiment, security is further enhanced, in that the code is only valid if entered within a set time limit after the code is sent to the user. The code still needs to be entered during the current session to be valid. Preferably, a value for the time limit is stored in the session. Advantageously, this ensures that the time limit is deleted when the session expires. If the user does not input the code before the session expires and, according to the preferred embodiment, within the time limit, the user must start again with a new session. This will require a new code to be sent. If the original code arrives in the mean time (possibly due to an excessively long email delivery time), it should be discarded as it will not be recognised by the new session.

The code is stored in session therefore the user must input the code in the same session from which the password reset was initiated. The code validates the user's choice of new password value but does not provide access to the secure resources that the password protects.

Operation of the invention will now be described in more detail with reference to the embodiment of FIG. 2. As shown in FIG. 2, the invention may be implemented as follows:
1. the operation is initiated with the user requesting a password reset or new password via browser 10;
2. in response to the user's request, the self-service application (SSA) 22 creates a session with the user and provides a page to the user's browser prompting for a username. The browser displays the page in a window. Preferably, if not already marked as invalid, the user's old password is now marked as invalid by the password authority;
3. the user responds to the prompt by entering the requested information in the browser window;
4. the self-service application uses the entered username to locate the user's profile stored in a database (i.e. LDAP authentication database 16, described above). If the correct profile cannot be found an error is detected and the user informed accordingly. If the user profile is found and indicates that the user is permitted to request a new password, the user is invited to confirm their identify to the password authority;
5. According to a preferred embodiment, confirmation of the user's identify may be achieved as follows:
   5.a. the self-service application prompts the user with one or more security questions;
   5.b. the user responds by entering in the browser window answers to the security questions;
   5.c. the self-service application verifies the user's response by referring to the user's profile (if incorrect, one or more repeat attempts may be permitted, in which case a count of invalid attempts incremented). If no valid response is obtained, an error is detected and the user informed accordingly;

6. if a valid response is detected from the user, the self-service application emails a code to the user's email account using the email address from the user's profile kept by the password authority. The password authority sets the user's password in the user's profile stored in the authentication database to a temporary string distinct from the code. The temporary password is a separate entity from the code and is kept hidden from the user;
7. having received the email, the user enters in the browser window the code contained in the email and enters (preferably in duplicate) a new password of their choosing;
8. the self-service application checks if the received code is valid by verifying the value of the code entered against the value sent to the user by email; verifying that it was entered by the user during the correct session and that the time limit (if any) has not been exceeded. If the code is found to be valid, the self-service application invokes the password authority to change the recorded password from the temporary password to the new password value entered by the user;
9. the self-service application informs the user that the password has been successfully changed. The user is logged in and is able to click on a link to be taken to a landing page (i.e. the original login page) identified by the calling (login) application via a redirect URL parameter.

According to a preferred embodiment, the invention is closely integrated with Siteminder password services. Siteminder password services provides several key functions including managing password policy, policy checking, password length setting, password change interval and password history. In order to update a password in the authentication directory of a Siteminder system, an application will need to use Siteminder password services.

To achieve this integration and to support the user in entering the new password without requiring the user to enter their old password (which may have been forgotten or compromised), requires the self-service application to reset the password field in the database to a temporary value that is hidden (i.e. not communicated to the user). It is then possible for the application to provide the hidden password and new password value selected by the user to Siteminder to change the recorded password in the conventional way (i.e. as if the user had logged in with a valid password). Whereas the conventional password reset process forces the user to change their password on next login, this not required for this new process.

There follows some sample code for submitting the password value in a secure fashion according to a preferred embodiment of the invention. The application developer needs to make the form hidden and submit the form on page load.

<FORM NAME=PWChange ACTION=“/siteminderagent/pw/PWS.fcc”
METHOD=POST>
<table><tr> <td><input type=hidden name=SMENC value=“UTF-8”>
<input type=text name=User value=“jeremy”><br>
<input type=text name=PASSWORD value=
“<c:out value=“${password}”/>” ><br>
<input type=text name=smauthreason value=“34”><br>
<input type=text name=target value=“/ssa/change-
password/redirect.do?url=/login/sindex.do”><br>
<input type=“submit” value=“Update”><br>
</table>
</FORM>

According to this preferred embodiment, the password request attribute should be set as follows:

```
import psServices.PasswordWriter;
String s = session.getAttribute(“randomPassword”); //random & hidden
String s1 = f.getNewPassword( );
String s2 = request.getParameter(“SMTOKEN”);
PasswordWriter passwordwriter = new PasswordWriter( );
passwordwriter.start(1);
passwordwriter.addParam(3, s);
if(s1 != null)
{
passwordwriter.addParam(4, s1);
    }
    if(s2 != null)
    {
            passwordwriter.addParam(6, s2);
    }
String s4 = passwordwriter.writeMessage( );
request.setAttribute(“password”, s4);
}
```

As will be understood by those skilled in the art, the invention may be implemented in software, any or all of which may be contained on various transmission and/or storage mediums such as a floppy disc, CD-ROM, or magnetic tape so that the program can be loaded onto one or more general purpose computers or could be downloaded over a computer network using a suitable transmission medium. The computer program product used to implement the invention may be embodied on any suitable carrier readable by a suitable computer input device, such as CD-ROM, optically readable marks, magnetic media, punched card or tape, or on an electromagnetic or optical signal.

Those skilled in the art will appreciate that the above embodiments of the invention are greatly simplified. Those skilled in the art will moreover recognise that several equivalents to the features described in each embodiment exist, and that it is possible to incorporate features of one embodiment into other embodiments. Where known equivalents exist to the functional elements of the embodiments, these are considered to be implicitly disclosed herein, unless specifically disclaimed. Accordingly, the spirit and scope of the invention is not to be confined to the specific elements recited in the description but instead is to be determined by the scope of the claims, when construed in the context of the description, bearing in mind the common general knowledge of those skilled in the art.

In particular, the skilled reader would appreciate that the communication system for sending the code to the user will, preferably, comprise an email system or some similar fast-response system such as instant messaging or short message service.

Above reference to the prior art is given for the purposes of providing background to the present invention and is not to be taken as an indication that the content of the prior art described constitutes common general knowledge.

1. A method for recording a password for providing access to secure resources in a computer network, the method including the steps of:
a user establishing a session via the computer network in which the user is in communication with a password authority via the session;
the user identifying themselves to the password authority via the session and requesting recording of a password via the session;
the password authority sending a code to the user otherwise than via the session;
the user receiving the code and providing the code to the password authority via the session;
the user providing a password value to the password authority via the 15 session;
the password authority receiving and checking the validity of the code provided by the user and, if the code entered is valid, recording the password value entered by user;
in which the code is only valid if provided via the session via which the 20 recording of a password is requested.

2. The method as claimed in claim 1, in which the code is only valid if entered within a set time limit after the code is sent by the password authority to the user.

3. The method as claimed in claim 1, in which the code is sent to the user by means of a communications system; in which the user is identified in the communications system by an address associated with the user by the password authority.

4. The method as claimed in claim 3, in which the address is an email address.

5. The method as claimed in claim 1, including on receiving the request from the user recording a temporary password and upon receiving the password value provided by the user using the temporary password to authorise recording of the password value provided by user.

6. The method as claimed in claim 1, in which the or each password is recorded in an authentication database.

7. A password authorisation system comprising a server for establishing a session via a computer network with a user, in which the user is in communication with the password authority via the session; in which the server is arranged to receive a request for recording a password from the user via the session;
in which the password authorisation system is arranged, in response to the request, to send a code to the user otherwise than via the session;
in which the server is arranged to receive the code and a password value from the user via the session in which the password authorisation system is arranged to receive and check the validity of the code received from the user and, if the code entered is valid, to record the password value received from the user;
in which the code is only valid if provided via the session via which the recording of a password is requested.

8. A password authorisation system as claimed in claim 7 in which the code is only valid if entered within a set time limit after the code is sent by the password authority to the user.

9. A password authorisation system as claimed in claim 7, comprising a communications server for sending the code to the user via a communications system; in which the user is identified in the communications system by an address associated with the user by the password authority.

10. A password authorisation system as claimed in claim 9 in which the address is an email address.

11. A password authorisation system as claimed in claim 7, arranged, on receiving the request from the user, to record a temporary password and, upon receiving the password value provided by the user, to use the temporary password to authorise recording of the password value provided by user.

12. A password authorisation system as claimed in claim 7, in which the or each password is recorded in an authentication database.

13. A carrier medium carrying a computer program or set of computer programs adapted to carry out, when said program or programs is run on a data-processing system, each of the steps of the method of claim 1.
